(19) United States
(12) Patent Application Publication
(10) Pub. No.: US 2026/0010629 A1
(43) Pub. Date: Jan. 8, 2026

(54) FIRMWARE PROTECTING METHOD AND FIRMWARE PROTECTING DEVICE

(71) Applicant: ASUSTEK COMPUTER INC., TAIPEI (TW)

(72) Inventors: Chi-Feng YANG, TAIPEI (TW); Ho-Yi CHANG, TAIPEI (TW); Bo-Chao JHAN, TAIPEI (TW); Chun-Han TU, TAIPEI (TW); Kuo-Wei HUANG, TAIPEI (TW)

(21) Appl. No.: 18/882,835

(22) Filed: Sep. 12, 2024

(30) Foreign Application Priority Data
Jul. 4, 2024 (TW) 113125118

(51) Int. Cl. G06F 21/57; H04L 9/08

(52) U.S. Cl. CPC G06F 21/572; H04L 9/0861; G06F 2221/033

(57) ABSTRACT

A firmware protecting device is provided, applied to an electronic device to protect firmware. The firmware protecting device includes a first memory, a second memory, and a control unit. The first memory is adapted to store the firmware. The control unit is electrically coupled to the first memory and the second memory. The control unit includes an encryption module, a detection module, and a decryption module. The encryption module is adapted to generate an encryption key, and encrypt the firmware by using the encryption key to generate encrypted data stored in the second memory. The detection module is adapted to detect the first memory to determine whether the firmware is tampered with. When it is detected that the firmware is tampered with, the decryption module is adapted to decrypt the encrypted data by using the encryption key to generate original firmware to replace the tampered firmware.

### CROSS-REFERENCE TO RELATED APPLICATION

This application claims the priority benefit of Taiwan Application Serial No. 113125118, filed on Jul. 4, 2024. The entirety of the above-mentioned patent application is hereby incorporated by reference herein and made a part of the specification.

### BACKGROUND OF THE INVENTION

### Field of the Invention

The disclosure relates to the field of computer data protection technologies, and in particular, to a firmware protecting method and a firmware protecting device.

### Description of the Related Art

With the popularization of network technologies and the advancement of digital business applications, people have an increasing high requirement on system security. However, existing firmware protecting methods often have the following shortcomings.

First, firmware is more likely to be tampered with and it is difficult to detect after the firmware is tampered with. Second, the firmware is difficult to repair after being tampered with. In addition, a network transaction key is also likely to be embezzled and copied.

### BRIEF SUMMARY OF THE INVENTION

The disclosure provides a firmware protecting device, applied to an electronic device to protect firmware. The firmware protecting device includes a first memory, a second memory, and a control unit. The first memory is adapted to store the firmware. The control unit is electrically coupled to the first memory and the second memory. The control unit includes an encryption module, a detection module, and a decryption module. The encryption module is adapted to generate an encryption key, and encrypt the firmware by using the encryption key to generate encrypted data stored in the second memory. The detection module is adapted to detect the first memory to determine whether the firmware is tampered with. When it is detected that the firmware is tampered with, the decryption module is adapted to decrypt the encrypted data by using the encryption key to generate original firmware to replace the tampered firmware.

The disclosure further provides a firmware protecting method. The firmware protecting method is applied to an electronic device to protect firmware. The electronic device includes a first memory, a second memory, and a control unit. The first memory is adapted to store the firmware. The firmware protecting method includes the following steps. First, a control unit generates an encryption key. Subsequently, the control unit encrypts the firmware by using the encryption key to generate encrypted data stored in a second memory. Then, the control unit detects the first memory to determine whether the firmware is tampered with. When it is detected that the firmware is tampered with, the control unit decrypts the encrypted data by using the encryption key to generate original firmware to replace the tampered firmware.

The firmware protecting device and the firmware protecting method provided in the disclosure can effectively prevent firmware from being maliciously or unintentionally damaged, and automatically restore the firmware when the firmware is tampered with, so as to ensure system stability and security of an electronic device.

### BRIEF DESCRIPTION OF THE DRAWINGS

FIG. 1 is a schematic structural diagram of a firmware protecting device according to an embodiment of the disclosure;

FIG. 2 shows functional modules in a control unit in FIG. 1;

FIG. 3 shows interaction among a control unit, a first memory, and a second memory in FIG. 1; and

FIG. 4 and FIG. 5 are flowcharts of a firmware protecting method according to an embodiment of the disclosure.

### DETAILED DESCRIPTION OF THE EMBODIMENTS

The following describes specific embodiments of the disclosure in more details with reference to the schematic diagrams. Based on the following description and a patent scope of the disclosure, advantages and features of the disclosure will be clearer. It should be noted that, the accompanying drawings are in simplified forms and are not drawn to an accurate scale, and are only used for assisting in describing the embodiments of the disclosure conveniently and clearly.

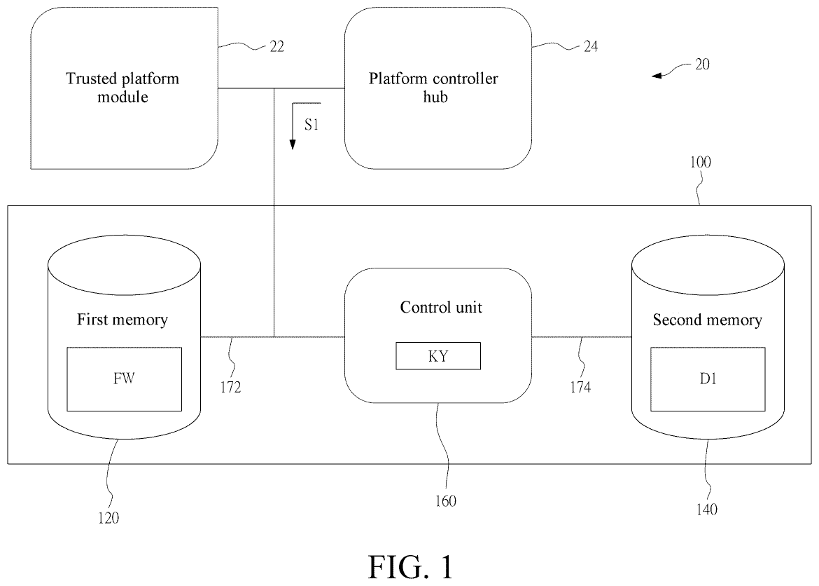

FIG. 1 is a schematic structural diagram of a firmware protecting device 100 according to an embodiment of the disclosure. The firmware protecting device 100 provided in the disclosure is applied to an electronic device 20 to protect firmware FW.

In an embodiment, the electronic device 20 is a hardware device such as a desktop computer, a notebook computer, a tablet computer, a smartphone or a server, or a motherboard in which the firmware FW is built. In an embodiment, the firmware FW is a basic input/output system (BIOS) installed on a motherboard.

As shown in the figure, the firmware protecting device 100 in the disclosure includes a first memory 120, a second memory 140, and a control unit 160. In an embodiment, the first memory 120, the second memory 140, and the control unit 160 are arranged on a motherboard (not shown in the figure).

The first memory is 120 is adapted to store the firmware FW. The control unit 160 is electrically coupled to the first memory 120 and the second memory 140, and is adapted to detect the first memory 120 and perform data access on the second memory 140. In an embodiment, both the first memory 120 and the second memory 140 are read-only memories (ROMs). In an embodiment, as shown in FIG. 1, the control unit 160 communicates with the first memory 120 and the second memory 140 respectively through two serial peripheral interfaces (SPIs) 172 and 174.

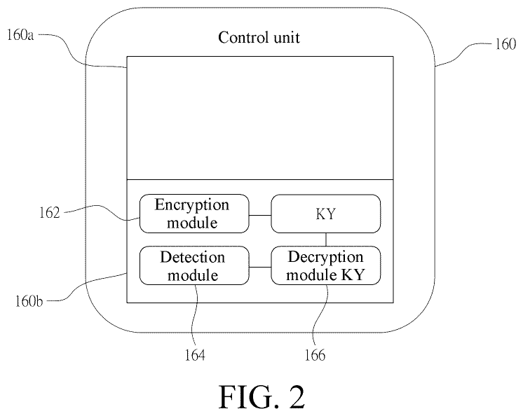

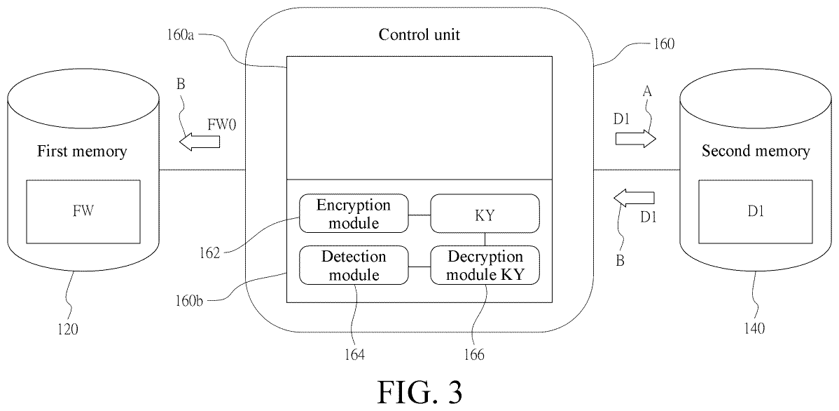

Referring to FIG. 2 and FIG. 3 together, FIG. 2 shows functional modules in the control unit 160 in FIG. 1, and FIG. 3 shows interaction among the control unit 160, the first memory 120, and the second memory 140 in FIG. 1.

As shown in the figure, in terms of functions, the control unit 160 includes an encryption module 162, a detection module 164, and a decryption module 166.

Referring to an arrow A in FIG. 3, the encryption module 162 is adapted to generate an encryption key KY, and encrypt the firmware FW by using the encryption key KY to generate encrypted data D1 stored in the second memory 140.

The detection module 164 is adapted to detect the first memory 120 to determine whether the firmware FW is tampered with. In an embodiment, the detection module 164 of the control unit 160 calculates a calculated value by using a hash algorithm for the firmware FW in the first memory 120, and compares the calculated value with a preset value to determine whether the firmware FW is tampered with.

Referring to an arrow B in FIG. 3, when it is detected that the firmware FW is tampered with, the decryption module 166 is adapted to decrypt the encrypted data D1 by using the encryption key KY to generate original firmware FW0 to replace the tampered firmware FW in the first memory 120.

In an embodiment, the control unit 160 is an embedded controller (EC). The embedded controller includes a common access area 160a and a safe access area 160b, where the common access area 160a and the safe access area 160b include different access rights, and the common access area 160a and the safe access area 160b are distinguished by hardware.

In an embodiment, as shown in the figure, the encryption module 162, the detection module 164, and the decryption module 166 are located in the safe access area 160b of the embedded controller, and the encryption key KY is stored in the safe access area 160b. Further, in an embodiment, to securely store the encryption key KY, the encryption key KY generated by the encryption module 162 is additionally stored in a hardware security module (HSM) (not shown in the figure). The hardware security module is an expansion card or an external device.

In addition to automatically detecting whether the firmware FW is tampered with, the firmware protecting device 100 of the disclosure further generates the original firmware FWO to replace the tampered firmware FW when the firmware FW is tampered with, or corrects the firmware FW according to a debugging instruction S1 from the outside.

Specifically, referring to FIG. 1, the electronic device 20 includes a trusted platform module (TPM) 22 and a platform controller hub (PCH) 24. The trusted platform module 22 is adapted to communicate with the first memory 120 to determine whether the firmware FW is tampered with. When the trusted platform module 22 detects that the firmware FW is tampered with, the trusted platform module 22 notifies the control unit 160 through the platform controller hub 24. Subsequently, the control unit 160 decrypts the encrypted data D1 by using the encryption key KY to generate the original firmware FWO to replace the tampered firmware FW in the first memory 120.

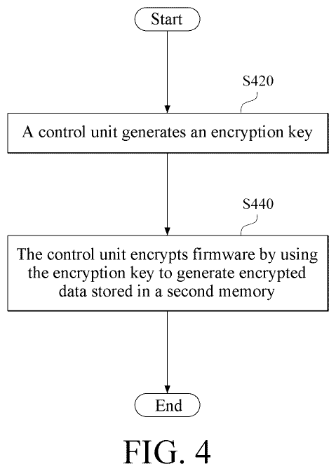

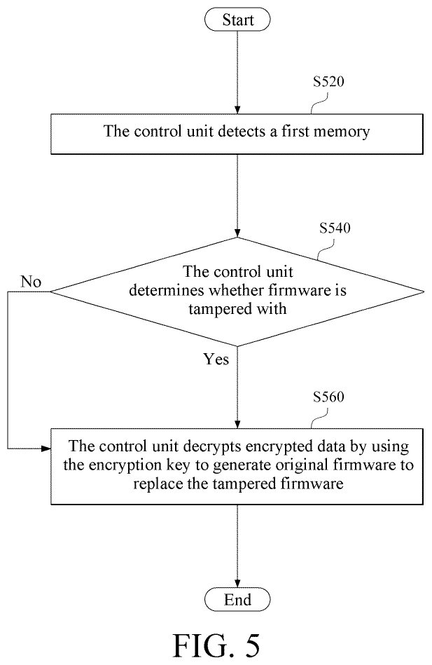

FIG. 4 and FIG. 5 are flowcharts of a firmware protecting method according to an embodiment of the disclosure. FIG. 4 shows a process of firmware encryption and protection. FIG. 5 shows a process of firmware detection and debugging.

The firmware protecting method is applied to the electronic device 20 shown in FIG. 1, and is performed by the firmware protecting device 100 in FIG. 1.

In an embodiment, as shown in FIG. 4, in the process of firmware encryption and protection: First, as described in step S420, the control unit 160 generates an encryption key KY. Subsequently, as described in step S440, the control unit 160 encrypts firmware FW by using the encryption key KY to generate encrypted data D1 stored in the second memory 140.

In an embodiment, the control unit 160 generates the encryption key KY after the electronic device 20 is turned on (i.e. booted) for the first time, to generate the encrypted data D1 stored in the second memory 140. In an embodiment, the encryption key KY generated by the control unit 160 is stored in the safe access area 160b in the control unit 160, or is stored in an external hardware security module.

Subsequently, as shown in FIG. 5, in the process of firmware detection and debugging: First, as described in steps S520 and S540, the control unit 160 detects the first memory 120, and determines whether the firmware FW is tampered with. When it is detected that the firmware FW is tampered with, the process proceeds to step S560 in which the control unit 160 decrypts the encrypted data D1 by using the encryption key KY to generate original firmware FW0 to replace the tampered firmware FW. When is detected that the firmware FW is not tampered with, the process ends.

In an embodiment, the step of firmware detection and debugging is performed after the electronic device 20 is powered on, and only after it is confirmed that the firmware FW in the first memory 120 is not tampered with or has been replaced with the original firmware FW0, the firmware FW in the first memory 120 that is not tampered with or the original firmware FW0 for replacement is performed to complete a boot procedure of a computer system.

Through the firmware protecting device 100 and the firmware protecting method provided in the disclosure, the control unit 160 generates the encryption key KY after the electronic device 20 is turned on for the first time, and encrypts the firmware FW by using the encryption key KY to generate the encrypted data D1 stored in the second memory 140 isolated from the first memory 120 on hardware as backup data for the firmware FW. Subsequently, when it is detected that the firmware FW is tampered with, the encrypted data D1 stored in the second memory 140 is used in conjunction with the encryption key KY, to generate the original firmware FW0 to replace the tampered firmware FW. In this way, the firmware FW can be effectively prevented from being maliciously or unintentionally damaged, and the firmware is automatically restored when the firmware FW is tampered with, so as to ensure system stability and security of the electronic device 20.

The foregoing merely describes preferred embodiments of the disclosure, and are not intended to limit the disclosure. Any form of equivalent replacements or modifications made by a person skilled in the art to the technical means and technical content disclosed in the disclosure without departing from the scope of the technical means of the disclosure do not depart from the content of the technical means of the disclosure and still fall within the protection scope of the disclosure.

What is claimed is:

1. A firmware protecting device, applied to an electronic device to protect firmware, the firmware protecting device comprising:
a first memory, adapted to store the firmware;
a second memory; and
a control unit, electrically coupled to the first memory and the second memory, and the control unit comprising:
an encryption module, adapted to generate an encryption key, and encrypt the firmware by using the encryption key to generate encrypted data stored in the second memory;
a detection module, adapted to detect the first memory to determine whether the firmware is tampered with; and
a decryption module, adapted to decrypt, when it is detected that the firmware is tampered with, the encrypted data by using the encryption key to generate original firmware to replace the tampered firmware.

2. The firmware protecting device according to claim 1, wherein the encryption key is stored in a hardware security module (HSM).

3. The firmware protecting device according to claim 1, wherein the firmware is a basic input/output system (BIOS).

4. The firmware protecting device according to claim 1, wherein the control unit is an embedded controller (EC), and the encryption key is stored in the embedded controller.

5. The firmware protecting device according to claim 4, wherein the embedded controller comprises a common access area and a safe access area, and the encryption key is stored in the safe access area.

6. The firmware protecting device according to claim 1, wherein the control unit generates the encryption key after the electronic device is turned on for the first time.

7. The firmware protecting device according to claim 1, wherein the first memory, the second memory, and the control unit are arranged on a motherboard.

8. The firmware protecting device according to claim 1, wherein the control unit calculates a calculated value by using a hash algorithm for the firmware in the first memory, and compares the calculated value with a preset value to determine whether the firmware is tampered with.

9. The firmware protecting device according to claim 1, wherein the control unit communicates with the first memory and the second memory respectively through two serial peripheral interfaces (SPIs).

10. The firmware protecting device according to claim 1, wherein the electronic device comprises a trusted platform module (TPM) and a platform controller hub (PCH), the trusted platform module is adapted to communicate with the first memory to determine whether the firmware is tampered with, and notify, when the firmware is tampered with, the control unit through the platform controller hub to use the encryption key to decrypt the encrypted data to generate the original firmware to replace the tampered firmware.

11. A firmware protecting method, applied to an electronic device to protect firmware, the electronic device comprising a first memory, a second memory, and a control unit, the first memory being adapted to store the firmware, and the firmware protecting method comprising:
generating, by the control unit, an encryption key;
encrypting, by the control unit, the firmware by using the encryption key to generate encrypted data stored in the second memory;
detecting, by the control unit, the first memory to determine whether the firmware is tampered with; and
decrypting, by the control unit when it is detected that the firmware is tampered with, the encrypted data by using the encryption key to generate original firmware to replace the tampered firmware.

12. The firmware protecting method according to claim 11, wherein the encryption key is stored in a hardware security module (HSM).

13. The firmware protecting method according to claim 11, wherein the firmware is a basic input/output system (BIOS).

14. The firmware protecting method according to claim 11, wherein the control unit is an embedded controller (EC), and the encryption key is stored in the embedded controller.

15. The firmware protecting method according to claim 14, wherein the embedded controller comprises a common access area and a safe access area, and the encryption key is stored in the safe access area.

16. The firmware protecting method according to claim 11, wherein the step of generating, by the control unit, the encryption key is performed after the electronic device is turned on for the first time.

17. The firmware protecting method according to claim 11, wherein the first memory, the second memory, and the control unit are arranged on a motherboard.

18. The firmware protecting method according to claim 11, wherein the step of detecting, by the control unit, the first memory to determine whether the firmware is tampered with comprises: calculating, by the control unit, a calculated value by using a hash algorithm for the firmware in the first memory, and comparing the calculated value with a preset value to determine whether the firmware is tampered with.
